(19) United States
(12) Patent Application Publication
(10) Pub. No.: US 2026/0142115 A1
(43) Pub. Date: May 21, 2026

(54) RASTERIZED LASER BEAMS FOR SWAPPING INTERCONNECT QUBIT STATES

(71) Applicant: IonQ, Inc., College Park, MD (US)

(72) Inventors: Isam Daniel MOORE, Bothell, WA (US); James David SIVERNS, Bothell, WA (US); Ryan Steven BOWLER, Kirkland, WA (US)

(21) Appl. No.: 19/391,535

(22) Filed: Nov. 17, 2025

Related U.S. Application Data
(60) Provisional application No. 63/722,398, filed on Nov. 19, 2024.

(51) Int. Cl. H01J 3/26; B82Y 10/00; G06N 10/20; G06N 10/40; H04B 10/70

(52) U.S. Cl. CPC H01J 3/26; B82Y 10/00; G06N 10/20; G06N 10/40; H04B 10/70

(57) ABSTRACT

A network of quantum information processing (QIP) systems includes a first QIP system, a second QIP system, and an optical system. The first QIP system includes a first ion trap that traps a first interconnect ion and a first memory ion in a first interconnect zone. The second QIP system includes a second ion trap configured to trap a second interconnect ion and a second memory ion in a second interconnect zone. The optical system directs a first optical beam and a second optical beam to the first interconnect zone to perform a SWAP gate to transfer information between the first interconnect ion and the first memory ion during a first duration, and directs the first optical beam and the second optical beam to the second interconnect zone to perform a SWAP gate to transfer information between the second interconnect ion and the second memory ion during a second duration.

### CROSS REFERENCE TO RELATED APPLICATION

The current application claims priority to U.S. Patent Provisional Application No. 63/722,398, filed on Nov. 19, 2024, the entire content of which is hereby incorporated by reference.

### TECHNICAL FIELD

Aspects of the present disclosure relate generally to systems and methods for use in the implementation, operation, and/or use of quantum information processing (QIP) systems, and more particularly, to operations of multiple QIP systems.

### BACKGROUND

Trapped atoms are one of the leading implementations for quantum information processing or quantum computing. Atomic-based qubits can be used as quantum memories, as quantum gates in quantum computers and simulators, and can act as nodes for quantum communication networks. Qubits based on trapped atomic ions enjoy a rare combination of attributes. For example, qubits based on trapped atomic ions have very good coherence properties, can be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an embodiment, a network of quantum information processing (QIP) systems includes a first QIP system, a second QIP system, and an optical system. The first QIP system includes a first ion trap configured to trap a first interconnect ion and a first memory ion in a first interconnect zone. The second QIP system includes a second ion trap configured to trap a second interconnect ion and a second memory ion in a second interconnect zone. The optical system is configured to direct a first optical beam and a second optical beam to the first interconnect zone to perform a SWAP gate to transfer information between the first interconnect ion and the first memory ion during a first duration, and direct the first optical beam and the second optical beam to the second interconnect zone to perform a SWAP gate to transfer information between the second interconnect ion and the second memory ion during a second duration.

In an aspect, a network of QIP systems can include a first QIP system including a first ion trap configured to trap a first interconnect ion and a first memory ion in a first interconnect zone and a second QIP system including a second ion trap configured to trap a second interconnect ion and a second memory ion in a second interconnect zone. An example of the network of QIP systems is shown in FIG. 5. The network of QIP systems can further include a first optical system configured to direct a first optical beam and a second optical beam to the first interconnect zone to perform a SWAP gate to transfer information between the first interconnect ion and the first memory ion during a first duration and a second optical system configured to direct a third optical beam and a fourth optical beam to the second interconnect zone to perform a SWAP gate to transfer information between the second interconnect ion and the second memory ion during a second duration. In an example, the first duration and the second duration overlap substantially in a time domain. In an example, the first optical system and the second optical system are configured to perform the respective SWAP gates in the first interconnect zone and the second interconnect zone simultaneously.

In an aspect of the present disclosure, a method for networked communication between at least a first and a second quantum information processing (QIP) system includes: trapping a first interconnect ion and a first memory ion in a first interconnect zone of a first ion trap of the first QIP system and trapping a second interconnect ion and a second memory ion in a second interconnect zone of a second ion trap of the second QIP system; and directing a first optical beam and a second optical beam to the first interconnect zone to perform a SWAP gate to transfer information between the first interconnect ion and the first memory ion during a first duration and directing the first optical beam and the second optical beam to the second interconnect zone to perform a SWAP gate to transfer information between the second interconnect ion and the second memory ion during a second duration.

A method for networked communication between at least the first and the second QIP system can include trapping the first interconnect ion and the first memory ion in the first interconnect zone of the first ion trap of the first QIP system and trapping the second interconnect ion and the second memory ion in the second interconnect zone of the second ion trap of the second QIP system. The method can further include directing the first optical beam and the second optical beam to the first interconnect zone to perform the SWAP gate to transfer information between the first interconnect ion and the first memory ion during the first duration and directing the third optical beam and the fourth optical beam to the second interconnect zone to perform the SWAP gate to transfer information between the second interconnect ion and the second memory ion during the second duration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects can be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of the present disclosure.

FIG. 2 illustrates an example of a quantum information processing (QIP) system in accordance with aspects of the present disclosure.

FIG. 3 illustrates an example of a computer device in accordance with aspects of the present disclosure.

FIG. 4 shows an ion trap according to aspects of the present disclosure.

FIG. 5 shows a schematic representation of an ion trap of a first QIP system and a second ion trap of a second QIP system.

FIG. 6 shows an example of optical beams interacting with ions trapped in an ion trap 270 according to an aspect of the disclosure.

FIG. 7 shows an example of an optical system according to an aspect of the disclosure.

FIG. 8 illustrates a method for networked communication between at least a first and a second QIP system according to an aspect of the present disclosure.

FIG. 9 illustrates an example of a QIP system 900 in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein can be practiced. The detailed description includes specific details for the purpose of providing a thorough understanding of various concepts. However, it will be apparent to those skilled in the art that these concepts can be practiced without these specific details or with variations of these specific details. In some instances, well known components are shown in block diagram form, while some blocks can be representative of one or more well known components.

As quantum computers improve and expand qubit counts, the scalability of the various subsystems can become an increasingly important concern. In some examples, for a trapped ion quantum computer, adding more qubits can put increasing demands on the required laser power for its quantum logic gates, which can create a complex array of optical elements and can limit the scalability. Thus, making repeated use of a given laser system rather than adding more laser systems for each additional qubit can be desirable.

According to an aspect of the disclosure, a single optical system (e.g., a single laser system) for implementing SWAP gates in each of multiple photonic interconnect trap zones is described. The single optical system can be used to swap a quantum state of a photonically-interconnected qubit into a memory ion in each interconnect zone of a plurality of QIP systems. The multiple interconnect zones can be in the respective QIPs (e.g., QPUs). The method entails generating optical beams (e.g., laser beams) such as a pair of optical beams for driving some two-qubit gate used to implement a SWAP gate in an interconnect zone with an appropriate beam geometry for coupling to the motional mode of interest between an interconnect ion and a memory ion in the interconnect zone. The pair of optical beams can be directed to each interconnect zone, e.g., with one or more acousto-optic deflectors (AODs).

In an example, the single optical system is configured to direct the pair of optical beams (e.g., a first optical beam and a second optical beam) to multiple positions where the multiple interconnect zones are located. For example, each optical beam is scanned (e.g., rasterized) over the multiple interconnect zones, and thus removing the need for multiple pairs of optical beams generated by multiple optical systems.

Since the probability of achieving more than one remote entanglement event per shot via photonic interconnects is relatively low, interconnect attempts can be paused when heralding entanglement and laser beams for the SWAP gate can be applied, for example, only at the zone of interest. Additionally, in some examples, for a judicious choice of the wavelengths of the pair of optical beams (e.g., the gate laser wavelengths), such optical beams can be repurposed from some existing Raman systems, thus further reducing the required number of lasers.

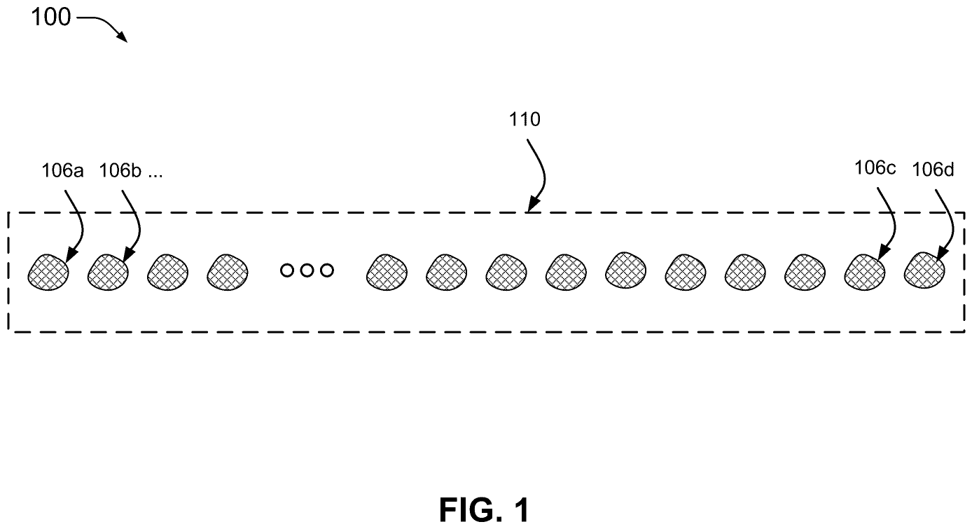

Solutions to the issues described above are explained in more detail in connection with FIGS. 1-9, with FIGS. 1-3 and 9 providing a general configuration of QIP systems or quantum computers, and more specifically, of atomic-based QIP systems or quantum computers.

Atomic quantum computers can include array(s) of atoms or ions trapped, for example, inside a vacuum chamber. A size and dimensionality of atomic arrays can vary.

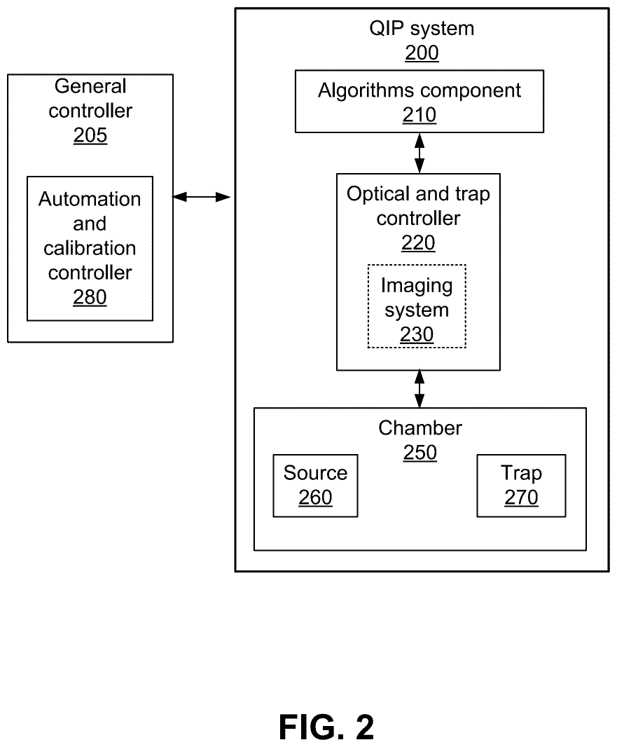

FIG. 1 illustrates a diagram 100 with multiple atomic ions or ions 106 (e.g., atomic ions 106a, 106b, . . . , 106c, and 106d) trapped in a linear crystal or chain 110 using a trap. In an example, the trap can be inside a vacuum chamber as shown in FIG. 2. The trap can be referred to as an ion trap. The ion trap shown can be built or fabricated on a semiconductor substrate, a dielectric substrate, or a glass die or wafer (also referred to as a glass substrate). The atomic ions 106 can be provided to the trap as atomic species for ionization and confinement into the chain 110. Some or all of the ions 106 can be configured to operate as qubits in a QIP system.

In the example shown in FIG. 1, the trap includes electrodes for trapping or confining multiple atomic ions into the chain 110. The multiple atomic ions can be laser-cooled to be nearly at rest. The number of atomic ions (N) trapped can be configurable and more or fewer atomic ions can be trapped. The atomic ions can be Ytterbium ions (e.g., ¹⁷¹Yb⁺ ions), for example. The atomic ions are illuminated with laser (optical) radiation tuned to a resonance in ¹⁷¹Yb⁺ and the fluorescence of the atomic ions is imaged onto a camera or some other type of detection device. Any suitable separation between atomic ions in a single cluster can be used. The separations can be uniform or non-uniform. The separation can vary based on an architectural configuration. A separation between atomic ions in a single cluster can range from 1 to 10 microns (μm). In an example, atomic ions can be separated by about 5 μm from each other, although the separation can be smaller or larger than 5 μm. The separation of the atomic ions is determined by a balance between the external confinement force and Coulomb repulsion and does not need to be uniform. In addition to atomic Ytterbium ions, neutral atoms, Rydberg atoms, different atomic ions or different species of atomic ions can be used. For example, ions of the same species, ions of different species, and/or different isotopes of ions can be used. The trap can be a linear radiofrequency (RF) Paul trap. Other types of confinement devices can also be used, including optical confinements. Thus, a confinement device can be based on different techniques and can hold ions, Rydberg atoms, and/or neutral atoms, for example, with an ion trap being one example of such a confinement device. The ion trap can be a surface trap, for example.

FIG. 2 shows a block diagram that illustrates an example of a QIP system 200 in accordance with various aspects of this disclosure. The QIP system 200 can be referred to as a quantum computing system, a quantum computer, a computer device, a trapped ion system, or the like. The QIP system 200 can be part of a hybrid computing system in which the QIP system 200 is used to perform quantum computations and operations. The hybrid computing system can include a classical computer to perform classical computations and operations. The quantum and classical computations and operations can interact in such a hybrid system.

Shown in FIG. 2 is a general controller 205 configured to perform various control operations of the QIP system 200. Instructions for the control operations can be stored in memory (not shown) in the general controller 205 and can be updated over time through a communications interface (not shown). Although the general controller 205 is shown separate from the QIP system 200, the general controller 205 can be integrated with or be part of the QIP system 200. The general controller 205 can include an automation and calibration controller 280 configured to perform various calibration, testing, and automation operations associated with the QIP system 200.

The QIP system 200 can include an algorithms component 210 that can operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 can provide instructions to various components of the QIP system 200 (e.g., to the optical and trap controller 220) to enable the implementation of the quantum algorithms or quantum operations. The algorithms component 210 can receive information resulting from the implementation of the quantum algorithms or quantum operations and can process the information and/or transfer the information to another component of the QIP system 200 or to another device for further processing.

The QIP system 200 can include an optical and trap controller 220 that controls various aspects of a trap 270 in a chamber 250, including the generation of signals to control the trap 270, and controls the operation of lasers and optical systems that provide optical beams that interact with the atoms or ions in the trap. Optical systems that include multiple components can be referred to as optical assemblies. The optical beams are used to initialize the ions, to perform or implement quantum algorithms, quantum applications, or quantum operations with the ions, and to read results from the ions. Control of the operations of laser, optical systems, and optical components can include dynamically changing operational parameters and/or configurations, including controlling positioning using motorized mounts or holders. When used to confine or trap ions, the trap 270 can be referred to as an ion trap. The trap 270, however, can also be used to trap neutral atoms, Rydberg atoms, different atomic ions or different species of atomic ions. In an example, the lasers and optical systems is at least partially located in the optical and trap controller 220 and/or in the chamber 250. For example, optical systems within the chamber 250 can be referred to as optical components or optical assemblies.

The QIP system 200 can include an imaging system 230. The imaging system 230 can include a high-resolution imager (e.g., CCD camera) or other type of detection device (e.g., a photomultiplier tube or a PMT) for monitoring the atomic ions while the atomic ions are being provided to the trap 270 and/or after the atomic ions have been provided to the trap 270. In an embodiment, the imaging system 230 can be implemented separately from the optical and trap controller 220. In an embodiment, the use of fluorescence to detect, identify, and label atomic ions using image processing algorithms can be coordinated with the optical and trap controller 220.

The QIP system 200 can include a source 260 that can provide atomic species (e.g., a plume or flux of neutral atoms) to the chamber 250 having the trap 270. When atomic ions are the basis of the quantum operations, the trap 270 can confine the atomic species when the atomic species are ionized (e.g., photoionized). The trap 270 can be part of a processor or processing portion of the QIP system 200. For example, the trap 270 can be considered as the core of the processing operations of the QIP system 200 since the trap 270 holds the atomic-based qubits that are used to perform the quantum operations or simulations. In an example, at least a portion of the source 260 can be implemented separately from the chamber 250.

It is to be understood that the various components of the QIP system 200 described in FIG. 2 are described at a high-level for ease of understanding. Such components can include one or more sub-components, the details of which can be provided below as needed to better understand certain aspects of this disclosure.

Aspects of this disclosure can be implemented at least partially using the general controller 205, the trap 270, the optical and trap controller 220, and/or the algorithms component 210.

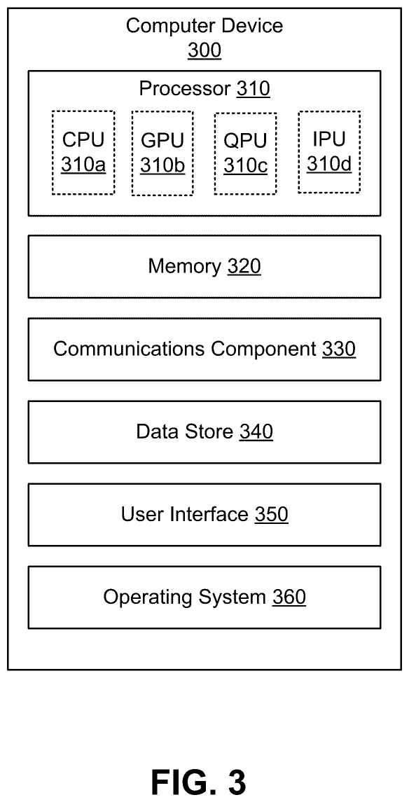

FIG. 3 shows an example of a computer system or device 300 in accordance with aspects of the disclosure. The computer device 300 can represent a single computing device, multiple computing devices, or a distributed computing system, for example. The computer device 300 can be configured as a quantum computer (e.g., a QIP system), a classical computer, or to perform a combination of quantum and classical computing functions, sometimes referred to as hybrid functions or operations. For example, the computer device 300 can be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 can include a processor 310 for carrying out processing functions associated with one or more of the features described herein. The processor 310 can include a single or multiple set of processors or multi-core processors. The processor 310 can be implemented as an integrated processing system and/or a distributed processing system. The processor 310 can include one or more central processing units (CPUs) 310a, one or more graphics processing units (GPUs) 310b, one or more quantum processing units (QPUs) 310c, one or more intelligence processing units (IPUs) 310d (e.g., artificial intelligence (AI) processors), or a combination of some or all those types of processors. In an example, the processor 310 can include one or more field-programmable gate arrays (FPGAs). In one aspect, the processor 310 can be referred to as a general processor of the computer device 300, which can also include additional processors 310 to perform more specific functions (e.g., including functions to control the operation of the computer device 300). Quantum operations can be performed by the QPUs 310c. Some or all of the QPUs 310c can use atomic-based qubits, however, different QPUs can be based on different qubit technologies.

The computer device 300 can include a memory 320 for storing instructions executable by the processor 310 to carry out operations. The memory 320 can store data for processing by the processor 310 and/or data resulting from processing by the processor 310. In an implementation, for example, the memory 320 can correspond to a computer-readable storage medium (e.g., a non-transitory computer-readable medium) that stores code or instructions to perform one or more functions or operations. The memory 320 can be referred to as a general memory of the computer device 300, which can also include additional memories 320 to store instructions and/or data for more specific functions.

It is to be understood that the processor 310 and the memory 320 can be used in connection with different operations including but not limited to computations, calculations, simulations, controls, calibrations, system management, and other operations of the computer device 300, including any methods or processes described herein.

The computer device 300 can include a communications component 330 that provides for establishing and maintaining communications with one or more parties utilizing hardware, software, and services. The communications component 330 can also be used to carry communications between components on the computer device 300, as well as between the computer device 300 and external devices, such as devices located across a communications network and/or devices serially or locally connected to computer device 300. For example, the communications component 330 can include one or more buses, and can further include transmit chain components and receive chain components associated with a transmitter and receiver, respectively, operable for interfacing with external devices. The communications component 330 can be used to receive updated information for the operation or functionality of the computer device 300.

The computer device 300 can include a data store 340, which can be any suitable combination of hardware and/or software, which provides for mass storage of information, databases, and programs employed in connection with the operation of the computer device 300 and/or any methods or processes described herein. For example, the data store 340 can be a data repository for operating system 360 (e.g., a classical OS, or a quantum OS, or both). In one implementation, the data store 340 can include the memory 320. In an implementation, the processor 310 can execute the operating system 360 and/or applications or programs, and the memory 320 or the data store 340 can store the operating system 360 and/or applications or programs.

The computer device 300 can include a user interface component 350 configured to receive inputs from a user of the computer device 300 and further configured to generate outputs for presentation to the user or to provide to a different system (directly or indirectly). The user interface component 350 can include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 can include one or more output devices, including but not limited to a display, a speaker, a haptic feedback mechanism, a printer, any other mechanism capable of presenting an output to a user, or any combination thereof. In an implementation, the user interface component 350 can transmit and/or receive messages corresponding to the operation of the operating system 360. When the computer device 300 is implemented as part of a cloud-based infrastructure solution, the user interface component 350 can be used to allow a user of the cloud-based infrastructure solution to remotely interact with the computer device 300.

In connection with the systems described in FIGS. 1-3, ion-photon entanglement is used to allow QIP systems within the network to communicate with each other using a photonic link. In some aspects, entanglement between QIP systems is detected by heralding entanglement between ions in different ion chains in different QIP systems, for example when photonic interconnect and photon collection and quantum computing procedures are being carried out simultaneously.

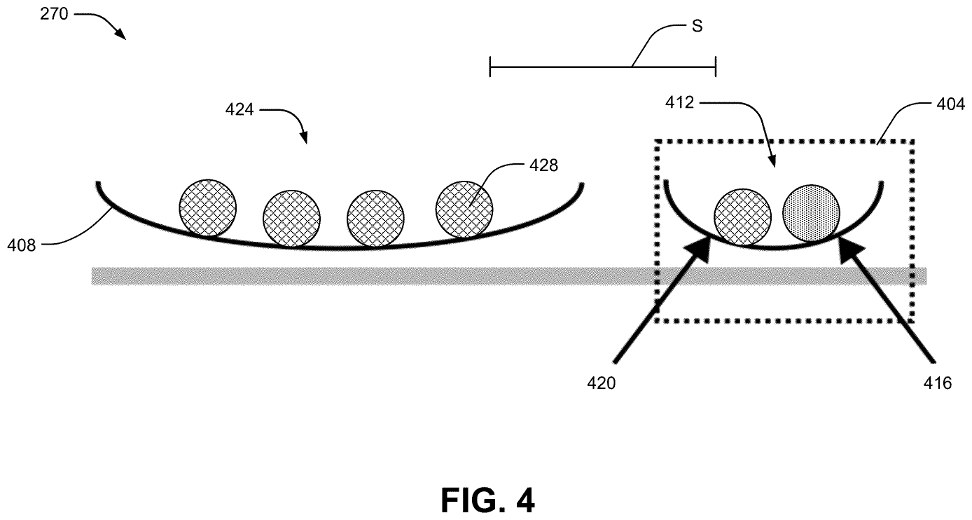

FIG. 4 shows the ion trap 270 according to aspects of the present disclosure. The ion trap 270 represents a detailed implementation of the ion trap 270 described above with respect to FIG. 2. The ion trap 270 incudes a first trapping zone 404 (e.g., an interconnect zone that can be referred to as a photonic interconnect trap zone) and a second trapping zone 408 (e.g., a computational zone). The interconnect zone 404 is spaced apart from the computational zone 408 such that the interconnect zone 404 and the computational zone 408 do not overlap and are optically isolated from each other. A spacing S between the interconnect zone 404 and the computational zone 408 is sized such that beams used to interact with ions in the interconnect zone 404 does not interact with the ions trapped in the computational zone 408 and such that beams used to interact with ions trapped in the computational zone 408 do not interact with ions trapped in the interconnect zone 404. The spacing S is also configured and sized such that photon emissions from ions trapped in the interconnect zone 404 do not overlap with the computational zone 408. Therefore, the photonic interconnect procedures occurring in the interconnect zone 404 do not interfere with quantum computing procedures occurring in the computational zone 408. In some aspects, the spacing S between the interconnect zone 404 and the computational zone 408 can be 90 μm to 100 μm. In some aspects, the spacing S can refer to a distance between the ion in the first ion chain 412 that is closest to the second ion chain 424. This prevents crosstalk between the photonic interconnect procedures carried out in the interconnect zone 404 and the quantum computing procedures carried out in the computational zone 408.

The interconnect zone 404 has a first trapping potential and is configured to trap the first ion chain 412 of trapped ions. The first ion chain 412 includes at least one interconnect ion 416 and at least one memory ion 420. The first trapping potential is optimized for trapping the interconnect ion(s) 416 and the memory ion(s) 420.

In some aspects, the interconnect ion(s) 416 can be different ion species than the memory ion(s) 420 and/or the computational ion(s) 428. As used herein, the phrase “ion species” means a particular ion element and/or isotope of a particular element. In such aspects, the wavelengths of light used to manipulate the interconnect ion(s) 416 can be sufficiently different than the wavelengths of light used to manipulate the memory ion(s) 420 and/or the computational ion(s) 428 that the wavelengths of light used to manipulate the interconnect ion(s) 416 does not effect the memory ion(s) 420 and/or the computational ion(s) 428, and vice versa. In such configurations, cross-talk between the different ion species can be minimal. In such aspects, the spacing S between the interconnect zone 404 and the computational zone 408 can be minimized.

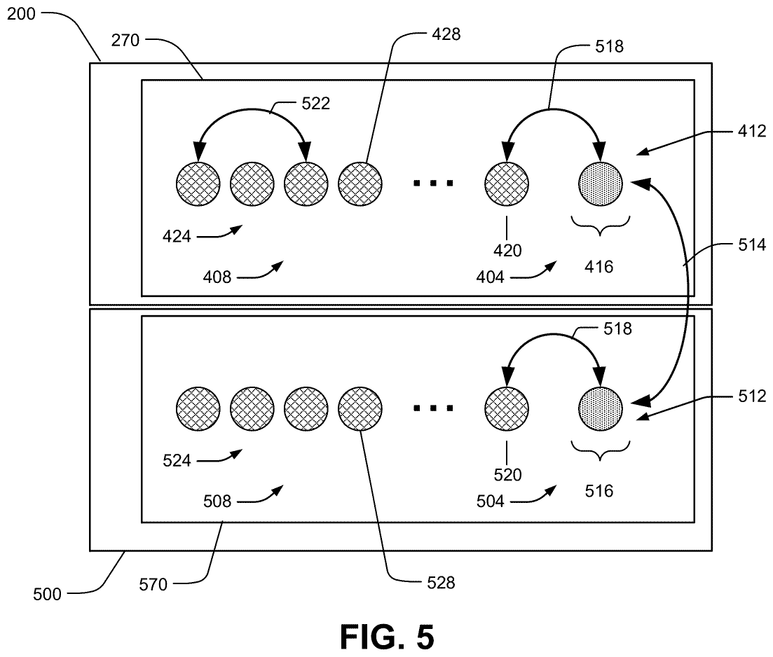

The at least one interconnect ion 416 is configured for entanglement with at least one interconnect ion in a second ion trap 570 (FIG. 5) of a second QIP system 500 (FIG. 5). In some aspects, the interconnect ion(s) 416 can be polarization-based photonic qubits. For example, the interconnect ion(s) 416 can be entangled with interconnect ion(s) in another QIP system 500 by producing a photon through a laser pulse sequence in the interconnect zone 404 to make an ion-photon entangled state between the interconnect ion(s) 416 and the photon. By doing this simultaneously in the interconnect zone 404 of the QIP system (e.g., a first QPU) 200 and interconnect ion(s) in the second QIP system (e.g., a second QPU) 500, and detecting the light via, for example, a Bell State analyzer, entanglement between ions in the first QPU 200 and the second QPU 500, or ion-ion entangled state, can be generated across the interconnect ion(s) in the two QIP systems 200 and 500.

After entanglement, the interconnect ion 416 includes information received from the second QIP system 500. In some aspects, the interconnect ion(s) 416 can include an ion species optimized for entanglement. As used herein, the phrase “ion species” means a particular ion and/or isotope of a particular element. Example ion species for interconnect ion(s) 416 can include ¹³⁸Ba⁺, ⁸⁸Sr⁺, ⁴⁰Ca⁺, ¹⁷⁴Yb⁺, ¹³⁷Ba⁺, and ¹⁷¹Yb⁺.

The memory ion(s) 420 are configured to store information received from the interconnect ion(s) 416 and/or the computational ions 428. The memory ion(s) 420 are configured to transmit stored information to the interconnect ion(s) 416 and/or the computational ions 428. For example, after entanglement, the quantum state of the interconnect ion(s) 416 can be transferred, via one or more gate operations, to the memory ion(s) 420. In some aspects, the memory ion(s) 420 can include an ion species optimized for stability, such that the memory ion(s) 420 can store information for a long time relative to the gate speeds used in photonic interconnect and/or quantum computing procedures. This can enable the memory ion(s) 420 to store information received from the interconnect ion(s) 416 until this information is needed by the quantum computing processes conducted by the computational ions 428. Example ion species for memory ion(s) 420 can include ¹³³Ba⁺, ⁴³Ca⁺, ¹³⁵Ba⁺, ¹³⁷Ba⁺, and ¹⁷¹Yb⁺. In some aspects, the memory ion(s) 420 can be a different ion species than the interconnect ion(s) 416.

In the configuration illustrated in FIG. 4, the memory ion(s) 420 are configured to receive information from the interconnect ion(s) 416 or transmit information to the interconnect ion(s) 416. For example, after the interconnect ion(s) 416 have become entangled with ion(s) of the second QIP system 500 (FIG. 5), a SWAP gate can be used to transfer information received from the second QIP system 500 from the entanglement ion(s) 416 to the memory ion(s) 420.

Although the interconnect ion(s) 416 and the memory ion(s) 420 are referred to above as separate co-trapped ions, in some aspects the interconnect and memory functionality can be accomplished by one ion. In such aspects, the memory functionality can be performed by a longer-lived qubit state of the interconnect ion(s) 416.

The computational zone 408 has a second trapping potential and is configured to trap a second ion chain 424 of trapped ions. The second ion chain 424 includes a plurality of computational ions 428. The computational ions 428 of the second ion chain 424 are configured for conducting quantum computing operations. In some aspects, the computational ions 428 can include an ion species optimized for conducting quantum computations. Example ion species for computational ions 428 can include ¹³³Ba⁺, ⁴³Ca⁺, ¹³⁵Ba⁺, ¹³⁷Ba⁺, and ¹⁷¹Yb⁺. In some aspects, the computational ions 428 can be a different ion species than the interconnect ion(s) 416. In such aspects, the species of the interconnect ion(s) 416 and the computational ions 428 can be selected such that they are excited by laser beams having wavelengths that do not excite any electrons in the computational ions 428. In some aspects, the memory ion(s) 420 and the computational ions 428 can be the same ion species. In other aspects, the memory ions(s) 420 and the computational ions 428 can be different ion species.

FIG. 5 shows a schematic representation of the ion trap 270 of the QIP system 200 and a second ion trap 570 of a second QIP system 500. Corresponding parts between the ion trap 270 and the ion trap 570 are shown using corresponding numbers, with numbering for the second ion trap 570 starting with the digit “5”.

As shown in FIG. 5, the interconnect ion(s) 416 of the first ion trap 270 and the interconnect ion(s) 516 of the second ion trap 570 are entangled via a photonic interconnect, as shown schematically by the arrow 514. As shown schematically by the arrows 518, SWAP gates can be used to transfer information received via the interconnect ion(s) 416, 516 to the memory ion(s) 420, 520, respectively. Quantum computing procedures conducted by the computational ions 428 in the computational zone 408 are shown by the arrow 522. As shown in FIG. 5, the interconnect zones 404, 504 of the first and second ion traps 270, 570 are spaced from the computational zones 408, 508 of the first and second ion traps 270, 570. Therefore, quantum computing operations (shown schematically by the arrows 522) conducted by the computational ions 428, 528 are not interrupted by the laser beams and photons involved in entangling the interconnect ion(s) 416, 516.

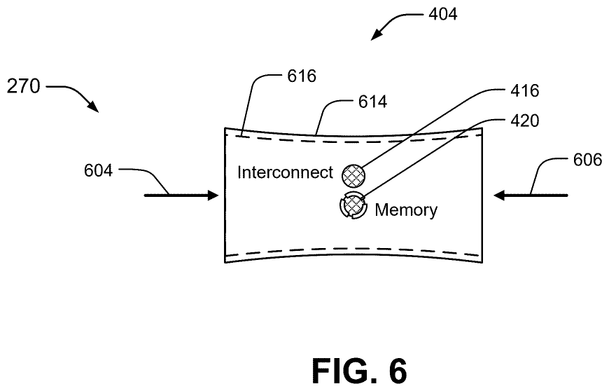

FIG. 6 shows an example of beams or optical beams 604 and 606 interacting with ions trapped in the ion trap 270 according to an aspect of the disclosure. The optical beams 604 and 606 can be laser beams generated from one or more lasers that are modified by optical components. The optical beams 604, 606 are configured to interact with the interconnect zone 404 that is in the ion trap 270. In some aspects, the beams 604, 606 can include the beams that conduct the SWAP operations between the interconnect ion(s) 416 and the memory ion(s) 420. In an example shown in FIG. 6, the beam 604 has a different wavelength than the beam 606. In aspects in which the memory ion(s) 420 are a different ion species than the interconnect ion(s) 416, the beams 604, 606 can include beams configured to sympathetically cool the memory ion(s) 420 to maintain the memory ion(s) in the ground state to increase their stability. As shown in FIG. 6, the area of the beams 604, 606 is shown schematically by boxes 614 and 616, respectively. In an aspect, the beams 604, 606 do not overlap with the computational ions 428 in the computational zone 408.

In an example, the interconnect zone 404 is spaced from the computational zone 408 such that the beams 604 and 606 interacting with the ions 416, 420 in the interconnect zone 404 do not interact with the ions 428 in the computational zone 408 and/or photons emitted by the interconnect ion(s) 416 do not interact with the ions 428 in the computational zone 408. In some examples, beams such as optical beams interacting with the ions 428 in the computational zone 408 do not interact with the ions 416, 420 in the interconnect zone 404. Therefore, the interconnect zone 404 and the computational zone 408 can be optically isolated from each other. This configuration prevents photonic interconnect procedures occurring in the interconnect zone 404 from interfering with quantum computing procedures occurring in the computational zone 408.

According to the exemplary aspect, the beams 604, 606 do not disrupt the quantum computing operations executed by the computational ions 428 in the computational zone 408. Information can be transferred between the memory ion(s) 420 and the interconnect ion(s) 416 or between the memory ion(s) 420 and the computational ions 428 at the beginning of a quantum computing process, in the middle of a quantum computing process, and/or at the end of a quantum computing process.

As quantum computers improve and expand qubit counts of the quantum computers, in some examples, the scalability of various subsystems become an increasingly important concern. For a trapped ion quantum computer, adding more qubits can put increasing demands on required laser power to implement quantum logic gates. Thus, in some examples, it can be desirable to make repeated use of a laser or a laser system, rather than adding more laser systems for each additional qubit.

An aspect of the disclosure describes a method for making an efficient use of laser beams (e.g., also referred to as gate-drive laser beams) for swapping a quantum state of a photonically-interconnected qubit into a memory ion. For example, a single optical system (e.g., a single laser system) can be used to implement SWAP gates in each of multiple photonic interconnect trap zones.

The disclosure describes a method that generates laser beams (e.g., a pair of laser beams) for driving a two-qubit gate in an interconnect zone (e.g., 404) with an appropriate beam geometry for coupling to the motional mode of interest, e.g., between an interconnect ion and a memory ion. The pair of laser beams can be scanned by optical deflecting apparatuses across different interconnect zones, for example, at different times such that the same pair of laser beams entering the optical deflecting apparatuses can propagate along different optical paths and swapping quantum states of photonically-interconnected qubits into respective memory ions. Thus, a single pair of laser beams can be used to swap N quantum states of N photonically-interconnected qubits into respective N memory ions instead of using N pairs of laser beams. Accordingly, the method and apparatuses in the disclosure can reduce the complexity of the laser system and make efficient use of the single laser system.

In an aspect, a network of QIP systems can include a plurality of QIP systems. The plurality of QIP systems can have any suitable number of QIP systems. The plurality of QIP systems can include a first QIP system (e.g., the QIP system 200), a second QIP system (e.g., the second QIP system 500), and the like. For purposes of brevity, FIG. 5 shows the two QIP systems 200 and 500 in the plurality of QIP systems. The first QIP system can include a first ion trap (e.g., the trap 270) configured to trap a first chain of trapped ions (e.g., the first ion chain 412) that includes a first interconnect ion such as the ion 416 and a first memory ion such as the memory ion 420. In an example, the first ion trap includes a first interconnect zone (e.g., the interconnect zone 404) and a first computational zone (e.g., the first computational zone 408). The first interconnect zone 404 includes the first chain of trapped ions (e.g., the first ion chain 412). The first computational zone 408 can include the ion chain 424. In some examples, the first interconnect zone 404 includes other ions such as additional memory ions and/or additional interconnect ions.

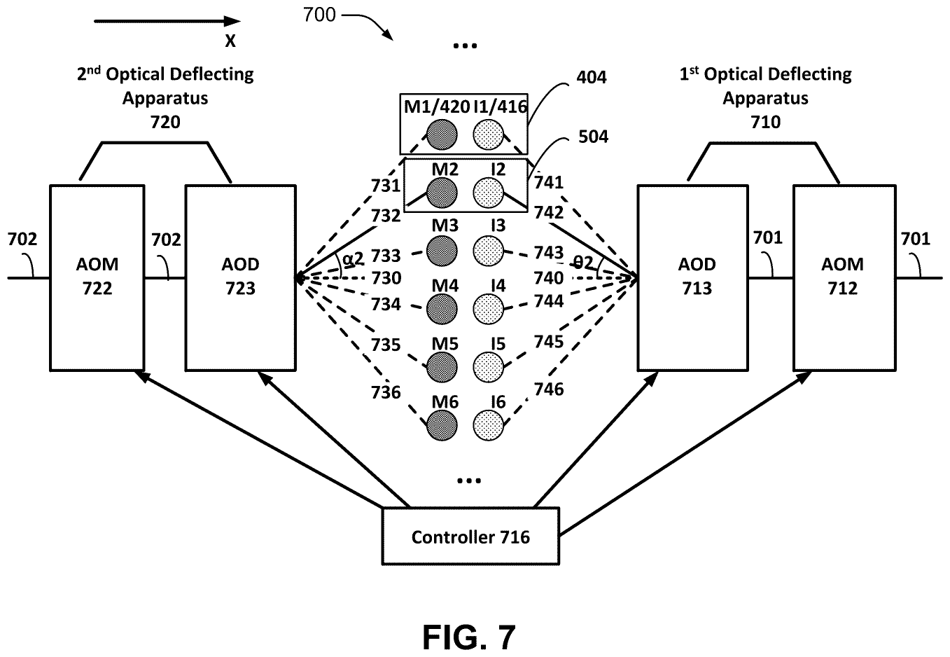

Referring to FIG. 5, the second QIP system can include a second ion trap (e.g., an example of the second ion trap is the trap 570 shown in FIG. 5) that is configured to trap a second chain of trapped ions (e.g., an example of the second chain of trapped ions is the ion chain 512 shown in FIG. 5) that includes a second interconnect ion such as the ion 516 and a second memory ion such as the memory ion 520. In an example, the second ion trap 570 includes a second interconnect zone (e.g., the interconnect zone 504) and a second computational zone (e.g., the first computational zone 508). The second interconnect zone 504 includes the second chain of trapped ions (e.g., the ion chain 512). The second computational zone 508 can include the ion chain 524. In some examples, the second interconnect zone 504 includes other ions such as additional memory ions and/or additional interconnect ions. The network of QIP systems can include an optical system (e.g., a laser system) 700 as shown in FIG. 7.

FIG. 7 shows an example of the optical system 700 according to an aspect of the disclosure. FIG. 7 also shows interconnect zones in respective ion traps in the plurality of QIP systems. Referring back to FIG. 5, the ion traps (not shown in FIG. 7) include the first ion trap 270, the second ion trap 570, four other ion traps, and the like. Memory ions in the respective interconnect zones are labeled with M1 to M6, and interconnect ions in the respective interconnect zones are labeled with I1 to I6. Referring to FIG. 7, the first interconnect ion 416 is also labeled with I1, the first memory ion 420 is also labeled with M1, the second interconnect ion 516 is labeled with I2, and the second memory ion 520 is labeled with M2. An ith interconnect zone in an ith QIP system includes the memory ion Mi and the interconnect ion Ii where i can be from 1 to 6, respectively. For example, the third interconnect zone in a third QIP system includes the memory ion M3 and the interconnect ion I3. For purposes of brevity, the details of the plurality of QIP systems are not shown in FIG. 7.

According to an aspect of the disclosure, the optical system 700 can be configured to direct a pair of optical beams such as a first optical beam (e.g., a first laser beam) 701 and a second optical beam (e.g., a second laser beam) 702 to the first interconnect zone 404 to perform a SWAP gate to transfer information between the first interconnect ion 416 (I1 in FIG. 7) and the first memory ion 420 (M1 in FIG. 7) during a first duration and direct the same pair of optical beams including the first optical beam 701 and the second optical beam 702 to the second interconnect zone 504 to perform a SWAP gate to transfer information between the second interconnect ion 516 (I2 in FIG. 7) and the second memory ion 520 (M2 in FIG. 7) during a second duration. In an example, the second duration is different from the first duration. Thus, the single optical system 700 can be configured to direct the pair of optical beams 701 and 702 to different interconnect zones (e.g., the interconnect zones 404 and 504), for example, to implement SWAP gates in each of the interconnect zones (also referred to as multiple photonic interconnect trap zones). In an aspect, SWAP gates can be implemented in each of the multiple interconnect zones (e.g., the interconnect zones 404 and 504) at different times.

In an example, the probability of achieving more than one remote entanglement event per shot via photonic interconnects (e.g., via I1 to I6) is low, interconnect attempts associated with I1 to I6 can be paused (e.g., laser beams directed to I1 to I6 to excite I1 to I6 respectively to extract photons entangled with corresponding qubits of I1 to I6 can be paused) when entanglement is heralded and a pair of laser beams (e.g., the first and second optical beams 701-702) for the SWAP gate can be applied only to the zone of interest (e.g., one of the interconnect zones such as 404 or 504 in FIG. 7). The pair of laser beams can (e.g., 701-702 in FIG. 7) can be different from the laser beams directed to I1 to I6 to excite I1 to I6 respectively to extract photons entangled with corresponding qubits of I1 to I6.

The optical system 700 can include one or more lasers that are configured to generate the first optical beam 701 and the second optical beam 702, a first optical deflecting apparatus 710, a second optical deflecting apparatus 720, and the like. The first optical deflecting apparatus 710 can be configured to direct the first optical beam 701 to different spatial positions or different interconnect zones. The first optical deflecting apparatus 710 can be configured to direct the first optical beam 701 to the first interconnect zone 404 and to direct the first optical beam 701 to the second interconnect zone 504, for example, during the first duration and during the second duration, respectively. Similarly, the second optical deflecting apparatus 720 can be configured to direct the second optical beam 702 to the first interconnect zone 404 and to direct the second optical beam 702 to the second interconnect zone 504, for example, during the first duration and during the second duration, respectively.

The first optical deflecting apparatus 710 and the second optical deflecting apparatus 720 can be implemented using any suitable optical components that can deflect a laser beam to different directions, for example, to implement SWAP gates in respective QIP systems. In an example, the first optical deflecting apparatus 710 and/or the second optical deflecting apparatus 720 can include an acoustic optical deflector (AOD) and an acoustic optical modulator (AOM) as shown in FIG. 7. In an example, the first optical deflecting apparatus 710 and/or the second optical deflecting apparatus 720 can include a mirror controlled electronically that replaces the AOD and the AOM.

An AOM and an AOD can be based on an interaction between light and sound waves such as an acousto-optic effect. In an aspect, an AOM and an AOD can serve different purposes and operate differently. An AOM can be used for modulating light properties, and an AOD can be used for controlling directions of light beams.

In an example, an AOM can be primarily used to modulate an intensity, a frequency, or a phase of a laser beam. During operation, a piezoelectric transducer generates sound waves in a material, creating a periodic variation in a refractive index and modulates the laser beam passing through the material so as to modulate the intensity, the frequency, or the phase of the laser beam.

In an example, an AOM can be primarily used to deflect or redirect a laser beam to different angles. During operation, an AOD is used to change an angle of the light beam. By varying the frequency of the sound wave, the angle of the diffracted light can be precisely controlled. Thus, an AOD can be used in a laser scanning system to scan or steer a laser beam to specific directions or positions.

In an example, the first optical deflecting apparatus 710 includes a first AOD 713 and a first AOM 712. The first AOD 713 can be used to deflect the first optical beam 701 along any suitable direction and thus to any suitable position, for example, the first AOD 713 deflects the first optical beam 701 to a particular ion (e.g., I2) or ions (e.g., M2 and I2) at a certain position. For example, the first AOD 713 can be configured to direct the first optical beam 701 to the first interconnect zone 404 during the first duration and to direct the first optical beam 701 to the second interconnect zone 504 during the second duration.

Referring to FIG. 7, the first optical beam 701 from a laser is incident to the first AOD 713, for example, along a direction 740 (−X direction), the first AOD 713 can deflect the first optical beam 701 along one of different directions 741-746 based on an electronic signal applied to the first AOD 713. Different angles can be formed between the respective directions 741-746 and the direction 740.

FIG. 7 shows an example that occurs during the second duration where the first AOD 713 is configured to deflect the first optical beam 701 along the direction 742 with an angle θ2 between the direction 742 and the direction 740, and thus the first optical beam 701 can be directed to the second interconnect zone 504. During another duration, the first optical beam 701 can be deflected to a different interconnect zone, such as shown in FIG. 7.

The first AOM 712 can be configured to modulate or shift a frequency (or a wavelength) of the first optical beam 701. In an aspect, as the first optical beam 701 is deflected by the first AOD 713, a frequency shift to a frequency of the first optical beam 701 can occur. The first AOM 712 can be configured to compensate for frequency shifts to the first optical beam 701 during the first duration and during the second duration caused by the first AOD 713, respectively.

In an example, the second optical deflecting apparatus 720 includes a second AOD 723 and a second AOM 722. The second AOD 723 can be used to deflect the second optical beam 702 along any suitable direction and thus to any suitable position, and thus can deflect the second optical beam 702 to a particular ion (e.g., I2) or ions (e.g., M2 and I2) at a certain position. For example, the second AOD 723 can be configured to direct the second optical beam 702 to the first interconnect zone 404 during the first duration and to direct the second optical beam 702 to the second interconnect zone 504 during the second duration, respectively.

Referring to FIG. 7, the second optical beam 702 from a laser is incident to the second AOD 723, for example, along a direction 730 (+X direction), the second AOD 723 can deflect the second optical beam 702 along one of different directions 731-736 based on an electronic signal applied to the second AOD 723. Different angles can be formed between the respective directions 731-736 and the direction 730.

FIG. 7 shows an example that occurs during the second duration where the second AOD 723 is configured to direct the second optical beam 702 along the direction 732 with an angle α2 between the direction 732 and the direction 730, and thus the second optical beam 702 can be directed to the second interconnect zone 504. During another duration, the second optical beam 702 can be deflected to a different interconnect zone.

The second AOM 722 can be used to modulate or shift a frequency (or a wavelength) of the second optical beam 702. In an aspect, as the second optical beam 702 is deflected by the second AOD 723, a frequency shift to a frequency of the second optical beam 702 can occur. The second AOM 722 can be configured to compensate for frequency shifts to the second optical beam 702 during the first duration and during the second duration caused by the second AOD 723, respectively.

An optical deflecting apparatus (the first optical deflecting apparatus 710 or the second optical deflecting apparatus 720) can be configured to direct a single laser beam (701 or 702) in a spatial domain to different interconnect zones to implement SWAP gates in each of the interconnect zones. The single laser beam (701 or 702) can propagate along a same optical beam path before incident to the optical deflecting apparatus (710 or 720). The single laser beam incident to the optical deflecting apparatus (710 or 720) can propagate along different optical beam paths when exiting the optical deflecting apparatus (710 or 720), for example, based on the electronic signal applied to the optical deflecting apparatus (710 or 720).

The first optical beam 701 and the second optical beam 702 can have any suitable beam geometry for coupling to the motional mode of interest, for example, between an interconnect ion and a memory ion in an interconnect zone.

In an aspect, the first optical beam 701 overlaps with the interconnect ion and the memory ion in the interconnect zone when the first optical beam 701 is directed to the interconnect zone. In an aspect, the second optical beam 702 overlaps with the interconnect ion and the memory ion in the interconnect zone when the second optical beam 702 is directed to the interconnect zone. In an example, the first optical beam 701 and the second optical beam 702 are indicated by the beams 604 and 606 shown in FIG. 6. For example, during the first duration, the first optical beam 701 overlaps with the first interconnect ion 416 and the first memory ion 420 in the first interconnect zone 404, and the second optical beam 702 overlaps with the first interconnect ion 416 and the first memory ion 420 in the first interconnect zone 404. For example, during the second duration, the first optical beam 701 overlaps with the interconnect ion I2 and the memory ion M2 in the second interconnect zone 504, and the second optical beam 702 overlaps with the interconnect ion I2 and the memory ion M2 in the second interconnect zone 504.

In an aspect, the first optical beam 701 overlaps with the interconnect ion in the interconnect zone and does not overlap with the memory ion in the interconnect zone when the first optical beam 701 is directed to the interconnect zone. In an aspect, the second optical beam 702 does not overlap with the interconnect ion in the interconnect zone and overlaps with the memory ion in the interconnect zone when the second optical beam 702 is directed to the interconnect zone. For example, during the first duration, the first optical beam 701 overlaps with the first interconnect ion 416 and does not overlap with the first memory ion 420 in the first interconnect zone 404, and the second optical beam 702 does not overlap with the first interconnect ion 416 and overlaps with the first memory ion 420 in the first interconnect zone 404. For example, during the second duration, the first optical beam 701 overlaps with the interconnect ion I2 and does not overlap with the memory ion M2 in the second interconnect zone 504, and the second optical beam 702 does not overlap with the interconnect ion I2 and overlaps with the memory ion M2 in the second interconnect zone 504.

Referring to FIG. 7, during the second duration, the first optical beam 701 and the second optical beam 702 overlap with the second interconnect zone 504. When the first optical beam 701 and the second optical beam 702 overlap with the second interconnect zone 504, the first optical beam 701 and the second optical beam 702 do not overlap with other interconnect zones such as the interconnect zone 404 and the like.

In an example, the first optical beam 701 and the second optical beam 702 enter the first interconnect zone 404 along different directions, such as the directions 731 and 741 during the first duration, as shown in FIG. 7. In an example, the first optical beam 701 and the second optical beam 702 enter the first interconnect zone 404 along opposite directions duration the first duration.

In an example, the first optical beam 701 and the second optical beam 702 enter the second interconnect zone 504 along different directions, such as the directions 732 and 742 during the second duration, as shown in FIG. 7. In an example, the first optical beam 701 and the second optical beam 702 enter the second interconnect zone 504 along opposite directions duration the second duration.

In an aspect, the interconnect zones including the memory ions M1-M6 and the interconnect ions I1-I6, the memory ions M1-M6, and the interconnect ions I1-I6 can be positioned at different locations in any suitable configuration, such as uniformly as shown in the example of FIG. 7, or non-uniformly (not shown in FIG. 7).

In an aspect, when the AOD (713 or 723) deflects a laser beam having a frequency (also referred to as an optical frequency) such as a center frequency f which corresponds to a wavelength λ, the AOD (713 or 723) can cause a frequency shift Δf to the frequency f. A magnitude IΔfI of the frequency shift can increase with the deflection angle. For example, the frequency shifts of the first optical beam 701 exiting the first AOD 713 corresponding to the directions 741 and 746 can have the largest magnitudes, and the frequency shifts of the second optical beam 702 exiting the second AOD 723 corresponding to the directions 731 and 736 can have the largest magnitudes. When the frequency shifts are above a threshold, the first optical beam 701 and the second optical beam 702 can not perform the SWAP gate.

According to an aspect of the disclosure, the first AOM 712 can be configured to compensate for a frequency shift to the first optical beam 701 caused by the first AOD 713 by causing an opposite frequency shift to the first optical beam 701.

In an aspect, during the first duration, a frequency shift to the first optical beam 701 caused by the first AOD 713 is compensated by a frequency shift caused by the first AOM 712 that has a substantially same magnitude and an opposite sign. In an aspect, during the second duration, a frequency shift to the first optical beam 701 caused by the first AOD 713 is compensated by a frequency shift caused by the first AOM 712 that has a substantially same magnitude and an opposite sign. Thus, a frequency of the first optical beam 701 during the first duration and a frequency of the first optical beam 701 during the second duration are substantially identical.

In an example, a frequency of the first optical beam 701 and a frequency of the second optical beam 702 depend on species of the first interconnect ion 416 and the first memory ion 420. For example, the frequency of the first optical beam 701 and the frequency of the second optical beam 702 are different.

In an example, the optical system 700 can include a controller 716 that is configured to control a timing of electronic signals that are applied to the first AOM 712, the first AOD 713, the second AOM 722, and the second AOD 723, respectively. For example, the electronic signals applied to the first AOM 712, the first AOD 713, the second AOM 722, and the second AOD 723 can be synchronized such that the first optical beam 701 and the second optical beam 702 are directed to the same interconnect zone (e.g., 504) during a same duration (e.g., during the second duration).

Referring to FIG. 7, during operation, the interconnect ion I2 in the interconnect zone 504 has achieved remote entanglement with an ion in another trap. A state of the interconnect ion I2 can be ready to be swapped into the memory ion M2. The pair of laser beams 701-702 are passed through the first AOM 712 and the second AOM 722, respectively (e.g., for frequency control of the laser beams 701-702) and the first AOD 713 and the second AOD 723, respectively. The first AOD 713 and the second AOD 723 direct the laser beams 701-702 to the desired interconnect zone 504. FIG. 7 also shows other possible, but inactive, beam paths along the directions 741, 743-746, 731, and 733-736 indicated by dashed lines.

In an example, the optical deflecting apparatus 710 or 720 can include a deformable mirror that is controlled via an electronic signal, and the first or the second optical beam 701 or 702 can be deflected (e.g., reflected) by the deformable mirror. For example, the first AOD 713 and first AOM 712 are replaced by the deformable mirror.

FIG. 7 shows an example using 6 interconnect zones. However, it should be appreciated that the optical system 700 can be configured to direct each of the optical beams 701 and 702 to N interconnect zones, and N can be any suitable positive numbers greater than one.

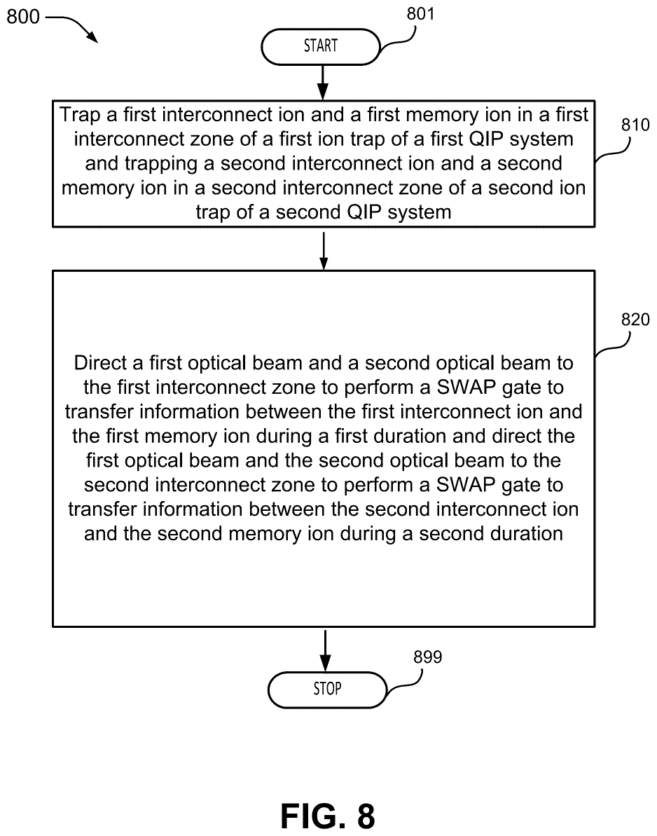

FIG. 8 illustrates a method 800 for networked communication between at least a first and a second quantum information processing (QIP) system according to an embodiment of the present disclosure. The method 800 can be performed by a network of the QIP systems 200 and 500, the computer device 300, and/or one or more subcomponents thereof as described above. The method 800 can start at 801.

At 810, the method includes trapping a first interconnect ion and a first memory ion in a first interconnect zone of a first ion trap of the first QIP system and trapping a second interconnect ion and a second memory ion in a second interconnect zone of a second ion trap of the second QIP system.

At 820, the method includes directing a first optical beam and a second optical beam to the first interconnect zone to perform a SWAP gate to transfer information between the first interconnect ion and the first memory ion during a first duration and directing the first optical beam and the second optical beam to the second interconnect zone to perform a SWAP gate to transfer information between the second interconnect ion and the second memory ion during a second duration.

The method 800 proceeds to 899, and terminates.

The method 800 can be suitably adapted. Step(s) in the method 800 can be modified and/or omitted. Additional step(s) can be added. Any suitable order of implementation can be used.

In an example, the directing the first optical beam to the first interconnect zone during the first duration and the directing the first optical beam to the second interconnect zone during the second duration are performed by a first acoustic optical deflector (AOD). The directing the second optical beam to the first interconnect zone during the first duration and the directing the second optical beam to the second interconnect zone during the second duration are performed by a second AOD. The method further includes: compensating for frequency shifts to the first optical beam during the first duration and during the second duration caused by the first AOD with a first acoustic optical modulator (AOM), and compensating for frequency shifts to the second optical beam during the first duration and during the second duration caused by the second AOD with a second AOM.

In an example, the compensating for the frequency shifts to the first optical beam includes: during the first duration, compensating one of the frequency shifts to the first optical beam caused by the first AOD with a frequency shift caused by the first AOM that has a substantially same magnitude and an opposite sign, and during the second duration, compensating another one of the frequency shifts to the first optical beam first caused by the first AOD with a frequency shift caused by the first AOM that has a substantially same magnitude and an opposite sign. A frequency of the first optical beam during the first duration and a frequency of the first optical beam during the second duration are substantially identical.

In an example, a frequency of the first optical beam during the first duration and a frequency of the second optical beam during the first duration depend on species of the first interconnect ion and the first memory ion.

In an example, the frequency of the first optical beam during the first duration and the frequency of the second optical beam during the first duration are different.

In an example, the first optical beam overlaps with the first interconnect ion and the first memory ion in the first interconnect zone during the first duration, and the second optical beam overlaps with the first interconnect ion and the first memory ion in the first interconnect zone during the first duration.

In an example, the first optical beam overlaps with the first interconnect ion and does not overlap with the first memory ion during the first duration, and the second optical beam does not overlap with the first interconnect ion and overlaps with the first memory ion during the first duration.

In an example, the first optical beam and the second optical beam enter the first interconnect zone along different directions duration the first duration.

In an example, the method includes controlling a timing of electronic signals that are applied to the first AOM, the first AOD, the second AOM, and the second AOD, respectively.

In an aspect, each QIP system can have a respective optical system (e.g., a rasterized SWAP gate laser system) for SWAP gates such that the SWAP gates in each QIP system can be performed simultaneously. In an aspect, a network of QIP systems can include a first QIP system including a first ion trap configured to trap a first interconnect ion and a first memory ion in a first interconnect zone and a second QIP system including a second ion trap configured to trap a second interconnect ion and a second memory ion in a second interconnect zone. An example of the network of QIP systems is shown in FIG. 5. The network of QIP systems can further include a first optical system configured to direct a first optical beam and a second optical beam to the first interconnect zone to perform a SWAP gate to transfer information between the first interconnect ion and the first memory ion during a first duration and a second optical system configured to direct a third optical beam and a fourth optical beam to the second interconnect zone to perform a SWAP gate to transfer information between the second interconnect ion and the second memory ion during a second duration. In an example, the first duration and the second duration overlap substantially in a time domain. In an example, the first optical system and the second optical system are configured to perform the respective SWAP gates in the first interconnect zone and the second interconnect zone simultaneously.

In an example, the first optical system includes a first optical deflecting apparatus and a second optical deflecting apparatus. The first optical deflecting apparatus can include a first AOD configured to direct the first optical beam to the first interconnect zone and a first AOM configured to compensate for a frequency shift to the first optical beam caused by the first AOD. The second optical deflecting apparatus can include a second AOD configured to direct the second optical beam to the first interconnect zone and a second AOM configured to compensate for a frequency shift to the second optical beam caused by the second AOD. The first optical system can be similar or identical to the optical system 700 described in FIG. 7.

In an example, the first optical beam overlaps with the first interconnect ion and the first memory ion in the first interconnect zone, and the second optical beam overlaps with the first interconnect ion and the first memory ion in the first interconnect zone.

In an example, the first optical beam overlaps with the first interconnect ion and does not overlap with the first memory ion, and the second optical beam does not overlap with the first interconnect ion and overlaps with the first memory ion.

In an example, the first optical beam and the second optical beam do not overlap with the second interconnect zone.

In an example, the frequency shift to the first optical beam caused by the first AOD is compensated with a frequency shift caused by the first AOM that has a substantially same magnitude and an opposite sign.

In an example, a frequency of the first optical beam and a frequency of the second optical beam depend on species of the first interconnect ion and the first memory ion.

In an example, the frequency of the first optical beam and the frequency of the second optical beam are different.

In an example, the first optical beam and the second optical beam enter the first interconnect zone along different directions.

In an example, the first optical beam and the second optical beam enter the first interconnect zone along opposite directions.

In an example, the network of the QIP system includes a controller that is configured to control a timing of electronic signals that are applied to the first AOM, the first AOD, the second AOM, and the second AOD, respectively.

In an example, the second optical system includes a third optical deflecting apparatus and a fourth optical deflecting apparatus. The third optical deflecting apparatus can include a third AOD configured to direct the third optical beam to the second interconnect zone and a third AOM configured to compensate for a frequency shift to the third optical beam caused by the third AOD. The fourth optical deflecting apparatus can include a fourth AOD configured to direct the fourth optical beam to the second interconnect zone and a fourth AOM configured to compensate for a frequency shift to the fourth optical beam caused by the fourth AOD. The second optical system can be similar or identical to the optical system 700 described in FIG. 7.

In an example, the third optical beam overlaps with the second interconnect ion and the second memory ion in the second interconnect zone, and the fourth optical beam overlaps with the second interconnect ion and the second memory ion in the second interconnect zone.

In an example, the third optical beam overlaps with the second interconnect ion and does not overlap with the second memory ion, and the fourth optical beam does not overlap with the second interconnect ion and overlaps with the second memory ion.

In an example, the third optical beam and the fourth optical beam do not overlap with the first interconnect zone.

In an example, the frequency shift to the third optical beam caused by the third AOD is compensated with a frequency shift caused by the third AOM that has a substantially same magnitude and an opposite sign.

In an example, a frequency of the third optical beam and a frequency of the fourth optical beam depend on species of the second interconnect ion and the second memory ion.

In an example, the frequency of the third optical beam and the frequency of the fourth optical beam are different.

In an example, the third optical beam and the fourth optical beam enter the second interconnect zone along different directions.

In an example, the third optical beam and the fourth optical beam enter the second interconnect zone along opposite directions.

In an example, the network of the QIP system includes a controller that is configured to control a timing of electronic signals that are applied to the first AOM, the first AOD, the second AOM, and the second AOD, the third AOM, the third AOD, the fourth AOM, and the fourth AOD, respectively.

A method for networked communication between at least the first and the second QIP system can include trapping the first interconnect ion and the first memory ion in the first interconnect zone of the first ion trap of the first QIP system and trapping the second interconnect ion and the second memory ion in the second interconnect zone of the second ion trap of the second QIP system. The method can further include directing the first optical beam and the second optical beam to the first interconnect zone to perform the SWAP gate to transfer information between the first interconnect ion and the first memory ion during the first duration and directing the third optical beam and the fourth optical beam to the second interconnect zone to perform the SWAP gate to transfer information between the second interconnect ion and the second memory ion during the second duration. The directing the first optical beam to the first interconnect zone can be performed by the first AOD, the directing the second optical beam to the first interconnect zone can be performed by the second AOD, the directing the third optical beam to the second interconnect zone can be performed by the third AOD, and the directing the fourth optical beam to the second interconnect zone can be performed by the fourth AOD. The method further includes compensating for the frequency shift to the first optical beam caused by the first AOD with the first AOM, compensating for the frequency shift to the second optical beam caused by the second AOD with the second AOM, compensating for the frequency shift to the third optical beam caused by the third AOD with the third AOM, and compensating for the frequency shift to the fourth optical beam caused by the fourth AOD with the fourth AOM. In an example, the respective SWAP gates in the first interconnect zone and the second interconnect zone are performed simultaneously by the first optical system and the second optical system.

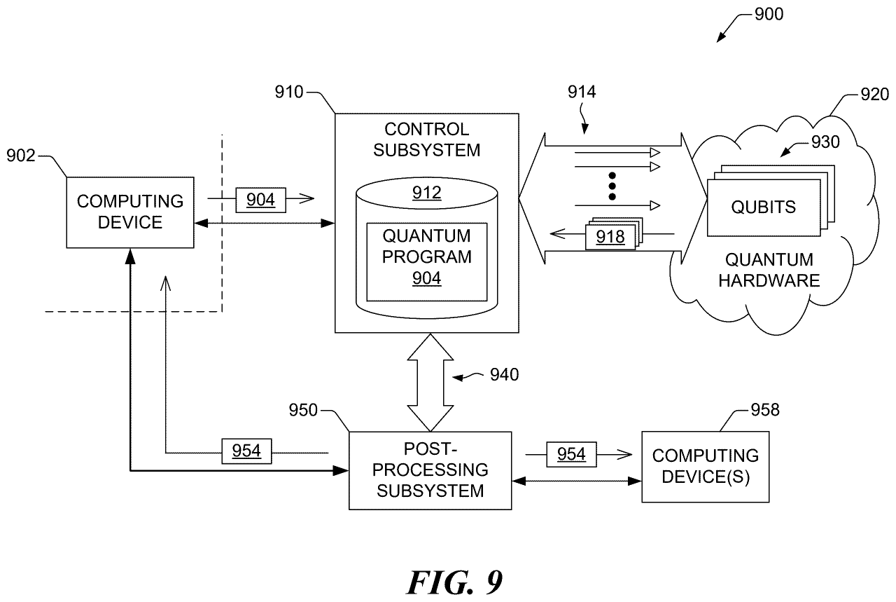

FIG. 9 illustrates an example of a QIP system 900 in accordance with aspects of this disclosure. The example QIP system 900 shown in FIG. 9 includes a control subsystem 910 that can receive a quantum program 904 from a computing device 902 that is remotely located relative to the example QIP system 900 and is functionally coupled (e.g., communicatively coupled) to the control subsystem 910. The computing device 902 can send data defining the quantum program 904 to control subsystem 910 for execution in quantum hardware 920, managing timing, synchronization, and logical routing of resource states for scalable multi-zone operation, as described herein. As is indicated by dashed lines, the computing device 902 can be external to the example QIP system 900. For example, the computing device 902 can be a user device (e.g., a classical computer) of an end-user of the QIP system 900. The control subsystem 910 can retain the quantum program 904 in one or more memory devices 912. The quantum program 904 corresponds to a defined quantum computation. The defined quantum computation can be an n-qubit computation, for example. The quantum program 904 can include a quantum circuit (and, in some cases, sub-circuits, such as the timing component, synchronization component, and routing component) representing a quantum algorithm associated with the quantum computation. Examples of the quantum algorithm include a variational quantum algorithm, a machine-learning algorithm, a Fourier transform algorithm, or the like.

The control subsystem 910 can be functionally coupled to quantum hardware 920 via multiple links 914 that permits the exchange of data and/or controls signal between the control subsystem 910 and the quantum hardware 920. The quantum hardware 920 can embody or can include one or more quantum computers. In some cases, the quantum hardware 920 embodies a cloud-based quantum computer. In other cases, the quantum hardware 920 embodies, or includes a local quantum computer. Regardless of its spatial footprint, the quantum hardware 920 includes multiple qubits 930 arranged in a particular layout. Each qubit of the qubits 930 can be coupled to an environment and/or to one another. Such coupling(s) decoheres and relaxes quantum information contained in the qubit. Thus, the quantum hardware 920 can be noisy. The type of the multiple links can be based on the type of qubits 930 used by the quantum hardware 920 for computation. In some cases, the multiple links 914 can include wireline links or optical links, or a combination of both. In other cases, the multiple links 914 can include microwave resonator devices or microwave transmission lines, or a combination of both.

The qubits 930 can include atomic qubits assembled in an atom-trap. Thus, the atomic qubits can be referred to as trapped-atom qubits. In some cases, each one of the atomic qubits can be a neutral atom. In other cases, each one of the atomic qubits can be an ion, such as an Ytterbium ion, a calcium ion, or similar ions. The atomic-qubits in such cases can be confined within an ion-trap (e.g., the trap 270 (FIG. 2) and can be assembled in a linear arrangement (such as the linear crystal or chain 110 (FIG. 1)). In other implementations, the qubits 930 can include solid-state devices of one of several types. Such devices can be embodied in, for example, Josephson junction devices, semiconductor quantum-dots, or defects in a semiconductor material (such as vacancies in Si and Ge, or nitrogen-vacancy centers in diamond).

The control subsystem 910 can cause the quantum hardware 920 to execute the quantum circuit and/or sub-circuits as described herein. In response, the control subsystem 910 can receive measurement data 918 indicative of computation outputs that includes the output of the non-local quantum operations, for example. Because the quantum computation can be performed in two or more qubits, a measurement outcome can be represented as a bitstring representing a particular target output state given a particular set of qubits involved in a quantum computation. The control subsystem 910 can supply at least a portion of the measurement data 918 to components of the control subsystem 910 and/or other subsystems (e.g., post-processing subsystem 950).

The control subsystem 910 also can be functionally coupled to a post-processing subsystem 950 via a communication architecture 940. The communication architecture 940 can include wirelines links, wireless links, network devices (such as gateway devices, servers, and the like), or a combination thereof. The post-processing subsystem 950 can apply one or several post-processing techniques to measurement data 918 received from the quantum hardware 920. By applying such techniques, the post-processing subsystem 950 can generate a result 954 of a quantum computation executed by the quantum hardware. The post-processing subsystem 950 can send the result 954 (or data indicative of the result 954) to the computing device 902 and/or other computing device(s) 958. The post-processing subsystem 950 also can cause the computing device 902 to present the result 954 in a particular way. For example, the post-processing subsystem 950 can direct the computing device 902 to present a user interface including the result 954.

As an example, the method for networked communication between multiple QIP systems, as described in FIG. 8, is implemented within the architecture illustrated in FIG. 9. The quantum hardware 920 comprises a plurality of ion trap systems where each ion trap system includes a plurality of zones, including, for example, an interconnect zone and a computational zone. These zones and the plurality of ion trap systems are orchestrated by the control subsystem 910 in coordination with a quantum program 904, which defines the timing and logic of the entanglement generation and quantum operations. These operations are carried out within the quantum hardware 920 and facilitated by precise routing defined in the quantum program 904. The entangled ions 930 are used to perform non-local quantum operations such as remote entangling gates or quantum teleportation. An example the entangled ions 930 include the interconnect ions 416 and 516 shown in FIG. 5. The resulting quantum state manipulations are evaluated and processed by the post-processing subsystem 950, completing the entanglement-assisted computation cycle.

Embodiments in the disclosure can be used separately or combined in any order.

The previous description of the disclosure is provided to enable a person skilled in the art to make or use the disclosure. Various modifications to the disclosure will be readily apparent to those skilled in the art, and the common principles defined herein can be applied to other variations without departing from the scope of the disclosure. Furthermore, although elements of the described aspects can be described or claimed in the singular, the plural is contemplated unless limitation to the singular is explicitly stated. Additionally, all or a portion of any aspect can be utilized with all or a portion of any other aspect, unless stated otherwise. Thus, the disclosure is not to be limited to the examples and designs described herein but is to be accorded the widest scope consistent with the principles and novel features disclosed herein.

What is claimed:

1. A network of quantum information processing (QIP) systems, comprising:
a first QIP system comprising a first ion trap configured to trap a first interconnect ion and a first memory ion in a first interconnect zone;
a second QIP system comprising a second ion trap configured to trap a second interconnect ion and a second memory ion in a second interconnect zone; and
an optical system configured to:
direct a first optical beam and a second optical beam to the first interconnect zone to perform a SWAP gate to transfer information between the first interconnect ion and the first memory ion during a first duration; and
direct the first optical beam and the second optical beam to the second interconnect zone to perform a SWAP gate to transfer information between the second interconnect ion and the second memory ion during a second duration.

2. The network of the QIP systems of claim 1, wherein the optical system comprises:
a first optical deflecting apparatus including:
a first acoustic optical deflector (AOD) configured to direct the first optical beam to the first interconnect zone during the first duration and to direct the first optical beam to the second interconnect zone during the second duration; and
a first acoustic optical modulator (AOM) configured to compensate for frequency shifts to the first optical beam during the first duration and during the second duration caused by the first AOD; and
a second optical deflecting apparatus including:
a second AOD configured to direct the second optical beam to the first interconnect zone during the first duration and to direct the second optical beam to the second interconnect zone during the second duration; and
a second AOM configured to compensate for frequency shifts to the second optical beam during the first duration and during the second duration caused by the second AOD.

3. The network of the QIP systems of claim 1, wherein
the first optical beam overlaps with the first interconnect ion and the first memory ion in the first interconnect zone during the first duration, and
the second optical beam overlaps with the first interconnect ion and the first memory ion in the first interconnect zone during the first duration.

4. The network of the QIP systems of claim 1, wherein
the first optical beam overlaps with the first interconnect ion and does not overlap with the first memory ion during the first duration, and
the second optical beam does not overlap with the first interconnect ion and overlaps with the first memory ion during the first duration.

5. The network of the QIP systems of claim 1, wherein
the first optical beam and the second optical beam do not overlap with the second interconnect zone during the first duration.

6. The network of the QIP systems of claim 2, wherein:
during the first duration, one of the frequency shifts to the first optical beam caused by the first AOD is compensated with a frequency shift caused by the first AOM that has a substantially same magnitude and an opposite sign;
during the second duration, another one of the frequency shifts to the first optical beam caused by the first AOD is compensated with a frequency shift caused by the first AOM that has a substantially same magnitude and an opposite sign; and
a frequency of the first optical beam during the first duration and a frequency of the first optical beam during the second duration are substantially identical.

7. The network of the QIP systems of claim 1, wherein a frequency of the first optical beam during the first duration and a frequency of the second optical beam during the first duration depend on species of the first interconnect ion and the first memory ion.

8. The network of the QIP systems of claim 7, wherein the frequency of the first optical beam during the first duration and the frequency of the second optical beam during the first duration are different.

9. The network of the QIP systems of claim 1, wherein the first optical beam and the second optical beam enter the first interconnect zone along different directions duration the first duration.

10. The network of the QIP systems of claim 9, wherein the first optical beam and the second optical beam enter the first interconnect zone along opposite directions duration the first duration.

11. The network of the QIP system of claim 2, further comprising a controller that is configured to control a timing of electronic signals that are applied to the first AOM, the first AOD, the second AOM, and the second AOD, respectively.

12. A method for networked communication between at least a first and a second quantum information processing (QIP) system, the method comprising:
trapping a first interconnect ion and a first memory ion in a first interconnect zone of a first ion trap of the first QIP system and trapping a second interconnect ion and a second memory ion in a second interconnect zone of a second ion trap of the second QIP system; and
directing a first optical beam and a second optical beam to the first interconnect zone to perform a SWAP gate to transfer information between the first interconnect ion and the first memory ion during a first duration and directing the first optical beam and the second optical beam to the second interconnect zone to perform a SWAP gate to transfer information between the second interconnect ion and the second memory ion during a second duration.

13. The method of claim 12, wherein
the directing the first optical beam to the first interconnect zone during the first duration and the directing the first optical beam to the second interconnect zone during the second duration are performed by a first acoustic optical deflector (AOD);
the directing the second optical beam to the first interconnect zone during the first duration and the directing the second optical beam to the second interconnect zone during the second duration are performed by a second AOD; and
the method further includes:
compensating for frequency shifts to the first optical beam during the first duration and during the second duration caused by the first AOD with a first acoustic optical modulator (AOM); and
compensating for frequency shifts to the second optical beam during the first duration and during the second duration caused by the second AOD with a second AOM.

14. A network of quantum information processing (QIP) systems, comprising:
a first QIP system comprising a first ion trap configured to trap a first interconnect ion and a first memory ion in a first interconnect zone;
a second QIP system comprising a second ion trap configured to trap a second interconnect ion and a second memory ion in a second interconnect zone;
a first optical system configured to direct a first optical beam and a second optical beam to the first interconnect zone to perform a SWAP gate to transfer information between the first interconnect ion and the first memory ion during a first duration; and
a second optical system configured to direct a third optical beam and a fourth optical beam to the second interconnect zone to perform a SWAP gate to transfer information between the second interconnect ion and the second memory ion during a second duration.

15. The network of the QIP systems of claim 14, wherein the first optical system comprises:
a first optical deflecting apparatus including:
a first acoustic optical deflector (AOD) configured to direct the first optical beam to the first interconnect zone; and
a first acoustic optical modulator (AOM) configured to compensate for a frequency shift to the first optical beam caused by the first AOD; and
a second optical deflecting apparatus including:
a second AOD configured to direct the second optical beam to the first interconnect zone; and
a second AOM configured to compensate for a frequency shift to the second optical beam caused by the second AOD.

16. The network of the QIP systems of claim 15, wherein:
the frequency shift to the first optical beam caused by the first AOD is compensated with a frequency shift caused by the first AOM that has a substantially same magnitude and an opposite sign.

17. The network of the QIP systems of claim 15, further comprising a controller that is configured to control a timing of electronic signals that are applied to the first AOM, the first AOD, the second AOM, and the second AOD, respectively.

18. The network of the QIP systems of claim 15, wherein the second optical system comprises:
a third optical deflecting apparatus including:
a third AOD configured to direct the third optical beam to the second interconnect zone; and
a third AOM configured to compensate for a frequency shift to the third optical beam caused by the third AOD; and
a fourth optical deflecting apparatus including:
a fourth AOD configured to direct the fourth optical beam to the second interconnect zone; and
a fourth AOM configured to compensate for a frequency shift to the fourth optical beam caused by the fourth AOD.

19. The network of the QIP systems of claim 18, wherein:
the frequency shift to the third optical beam caused by the third AOD is compensated with a frequency shift caused by the third AOM that has a substantially same magnitude and an opposite sign.

20. The network of the QIP systems of claim 18, further comprising a controller that is configured to control a timing of electronic signals that are applied to the first AOM, the first AOD, the second AOM, and the second AOD, the third AOM, the third AOD, the fourth AOM, and the fourth AOD, respectively.
